(19) United States
(12) Patent Application Publication
(10) Pub. No.: US 2002/0183235 A1
(43) Pub. Date: Dec. 5, 2002

(54) Polymer cleaner formulation

(76) Inventor: Sherman Jay Sprague, Twinsburg, OH (US)

Correspondence Address: Kelly L. Cummings, Paten & Licensing Department, ONDEO Nalco Company, 1 ONDEO Nalco Center, Naperville, IL, 60563-1198, US

(21) Appl. No.: 09/817,881

(22) Filed: Mar. 26, 2001

(51) Int. Cl. C11D 1/00

(52) U.S. Cl. 510/488

(57) ABSTRACT

Compositions and methods for cleaning polymers and residuals thereof that utilize solutions containing halide salts and carboxylic acids are provided. The polymer cleaning solutions of the present invention can be applied in a variety of different polymer removal applications, such as those relating to the cleaning of polymers from water treatment vessels, containers, process equipment or other like applications. The cleaning solutions can also be utilized to remove polymers and residuals thereof during spill cleanup activities relating to, for example, industrial spills, and transportation-related spills.

### FIELD OF THE INVENTION

The present invention relates to compositions and methods for cleaning polymers. More specifically, the present invention relates to compositions and methods for cleaning polymers that utilize a solution containing halide salts and carboxylic acids.

### BACKGROUND OF THE INVENTION

The use of polymers has a varied and expansive application in today's society. For example, a number of different polymers and polymer-based materials are commonly utilized to treat water associated with a variety of different water applications, such as industrial, commercial, residential and the like. In this regard, the polymers are typically added to the water to clarify it by, for example, reducing turbidity levels, removing color or removing other contaminants to achieve water clarity. The polymers generally cause the contaminants of the water to settle out or separate from the water such that the contaminants along with the polymers can be collected and removed from the water.

However, difficulties arise in removing the “settled out” polymer-base material due to the fact that commonly used polymers have a high viscosity such that these materials do not freely and easily flow. In other words, the polymers adhere to the surface of a water treatment vessel or other container or vessel during use thereof.

Commonly known and used polymer cleaning agents include caustic solutions that are both heavily sprayed and heated in order to effectively remove the polymer. The use of such polymer cleaning agents can result in, for example, health and safety issues associated with the handling of such materials and increased costs such as relating to the disposal of such material and to increased handling and operation time in order to clean the polymer.

A need, therefore exists, to provide compositions and methods for cleaning polymers that reduces costs associated with the removal and/or cleaning of polymers, that minimizes the problems typically associated with the handling and disposal of commonly used cleaning agents and that can be easily manufactured and applied to remove polymers associated with a variety of different applications, such as those relating to the removal of polymers that are utilized to treat water.

### SUMMARY OF THE INVENTION

The present invention provides compositions and methods for cleaning polymers in relation to a variety of different applications and activities, such as those relating to industrial, commercial and residential applications and spill cleanup activities. The polymer cleaning agent of the present invention generally includes a solution that contains halide salts and carboxylic acids. The solution composition can be effectively utilized to remove a variety of different polymers and mixtures thereof at reduced costs while minimizing problems generally associated with the use, handling and disposal of commonly known polymer cleaning materials.

To this end, in an embodiment of the present invention, a composition for removing polymers is provided. The composition includes a solution containing a carboxylic acid and a halide salt.

In another embodiment, a cleaning agent that can be used to remove polymers from a surface is provided. The polymer cleaning agent includes an aqueous solution containing a carboxylic acid and a halide salt having a metal component and a halide component.

In yet another embodiment, a method of cleaning a polymer is provided. The method includes the steps of providing a solution containing a halide salt and a carboxylic acid; and applying the solution to the polymer.

In still yet another embodiment, a method of removing a polymer is provided. The method includes the steps of providing a cleaning solution containing a halide salt and a carboxylic acid; applying the cleaning solution to the polymer during a spill cleanup; and removing the polymer.

It is, therefore, an advantage of the present invention to provide compositions and methods for cleaning polymers that utilize a solution containing halide salts and carboxylic acids.

Another advantage of the present invention is to utilize the polymer cleaning agent of the present invention to remove residual polymers from a surface upon which the residual polymer is adhered thereto.

A further advantage of the present invention is to remove polymers from containers, vessels or other like storage devices.

Yet another advantage of the present invention is to remove polymers during spill cleanup activities.

A still further advantage of the present invention is to provide a polymer cleaning solution that can be manufactured and utilized at reduced costs and that can be easily handled.

Additional features and advantages to the present invention are described in, and will be apparent in the detailed description of the presently preferred embodiments.

### DETAILED DESCRIPTION OF THE PRESENTLY PREFERRED EMBODIMENTS

The present invention relates to compositions and methods for cleaning polymers. More specifically, the present invention relates to compositions and methods for cleaning polymers that utilize a solution which contains halide salts and carboxylic acids. The polymer cleaning solutions of the present invention can be utilized at reduced cost and to effectively minimize handling and disposal issues typically associated with the use of commonly known polymer cleaning materials, such as heated caustic solutions.

The polymer cleaning agents of the present invention can be utilized to effectively clean or remove a variety of different polymers and combinations thereof associated with a variety of different applications. The polymers to be removed can include any commonly used polymer, such as solution polymers, emulsion polymers, latex polymers, dispersion polymers, other like polymers and combinations thereof. The polymers to be cleaned have any suitable molecular weight, such as a molecular weight ranging from about 1000 atomic mass units (“amu”) to about 50,000,000 amu. When applied to the polymers or residuals thereof, the cleaning solution of the present invention effectively reduces the viscosity of the polymers. In this regard, the polymers are effectively fluidized. Thus, the polymers can freely flow and be removed with relative ease by any suitable removal application, such as pumping, shoveling or other like removal applications.

The polymer cleaning solutions can be applied in a number of different applications. For example, the cleaning solutions of the present invention can be applied to polymers that have been utilized to treat and clarify water. The polymer cleaning agents of the present invention can also be applied to a number of different industrial, process, commercial, residential and other like polymer cleaning applications. Specific examples of such applications include container cleaning, truck cleaning, drum refurbishment, process equipment cleaning, waste system cleaning, industrial spills, transportation spills, paint processing and the like.

As previously discussed, the polymer cleaning agent of the present invention functions to decrease the viscosity of the polymer or polymer-based material such that the polymer can more freely flow from a surface upon which it is adhered thereto. Such surfaces include surfaces of any suitable container, vessel, piping or other like device that is utilized to contain, hold, process, transport or otherwise adapted to contact the polymer to be removed. Specific examples of such surfaces to be cleaned are those relating to, for example, drums, truck tanks, intermediate bulk containers associated with a variety of different transportation modes, such as truck, train, air or the like.

The polymer cleaning solutions of the present invention can also be utilized during spill cleanup activities to clean surfaces upon which polymers have spilled. For example, the cleaning agent of the present invention can be utilized to remove polymers and residuals thereof during a variety of different spill cleanups, such as industrial spill cleanups, tanker trucks spill cleanups, train derailment spill cleanups and the like.

To remove the polymer or residuals thereof, the cleaning solution of the present invention can be applied by a variety of different applications. For example, the cleaning solution can be poured, pumped, continuously sprayed and applied to the polymer in any suitable way to effectively clean the polymer. It should be appreciated that the polymer cleaning solution of the present invention is not required to be heated during use or application thereof.

As previously discussed, the polymer cleaning solution includes a solution composition which contains halide salts and carboxylic acids. The halide salt can include a variety of different materials and components. The halide salt preferably includes a metal component and a halide component. The metal component can include any suitable metal, such as monovalent and divalent metals. The metal component preferably includes calcium (“Ca”), potassium (“K”), magnesium (“Mg”), sodium (“Na”) or other like metals.

The halide component can include any suitable component. The component preferably includes chlorine (“C1”), Bromine (“Br”), Iodine (“I”), other suitable halogens or other like components.

The carboxylic acids of the cleaning solution composition can include any suitable carboxylic acid. Preferably, the carboxylic acids include those containing six or fewer carbon atoms, such as acetic acid, ethanoic acid, propianoic acid, butyric acid, oxalic acid, citric acid, mixtures thereof or the like.

The halide salt and carboxylic acid components of the solution can be utilized in any suitable number, variety and amount. Preferably, the halide salt ranges from about 1% to about 97% by weight. The carboxylic acid ranges from about 0.01% to about 50% by weight. More preferably, the cleaning solution of the present invention contains about 20% of calcium chloride dihydrate and about 0.2% of acetic acid.

The solution of the present invention can include any suitable solution such that it effectively dissolves the halide salt and carboxylic acid components. Preferably, the solution includes an aqueous solution. More preferably, the solution includes an aqueous solution that has a very low conductivity, such as deionized water, distilled water or other like solution.

In an embodiment, the solution also includes a dye component and a fragrance component. The dye can include any commercially available dye. The dye can be added in any suitable amount such that its associated color is visible within the solution. The fragrance can include any commercially available fragrance. It can be added in any suitable amount such that its associated odor is sensed.

The added color and fragrance can be utilized to facilitate the handling of the polymer cleaning. The added color makes the cleaning solution more visually apparent to the user. The added fragrance effectively eliminates any odor that may result from the metal halide and/or carboxylic acid components, such as the odor associated with acetic acid.

It should be appreciated that the polymer cleaning agent of the present invention can include any suitable number, amount and variety of the previously discussed components, such as, the halide salt, carboxylic acid, deionized water, dye and fragrance. In a preferred embodiment, the polymer cleaning solution of the present invention includes deionized water at about 79.7% by weight, calcium chloride dihydrate at about 20% by weight, acetic acid at about 0.2% by weight, dye at about 0.001% by weight and fragrance at about 0.1% by weight.

The cleaning solution of the present invention can also be maintained at any suitable pH level. Preferably, the pH level ranges from about 1.0 to about 4.0.

The polymer cleaning agent of the present invention can be readily manufactured in a variety of different suitable ways. In general, the halide salt and carboxylic acid components are added to an aqueous solution and dissolves therein. This process can be conducted under any suitable temperatures and pressures, such as room temperature and atmospheric pressure. It should be appreciated that temperatures above and/or below room temperature and pressures above and/or below atmospheric pressure are not required during the manufacturing and use of the present invention.

The halide salt and carboxylic acid components of the present invention are typically readily dissolvable in the aqueous solution under standard temperature and pressure. However, any suitable variety of process techniques can be utilized to facilitate the dissolution of such components, such as those techniques relating to shaking, vibrating, stirring, heating or other like techniques.

By way of example and not limitation, examples of the present invention are provided as follows:

### EXAMPLE 1

Laboratory tests were conducted to evaluate the effectiveness of a polymer cleaning solution containing deionized water (“D.I. water”) at 78.9% by weight, calcium chloride dihydrate at 20% by weight and acetic acid at 0.2% by weight. In particular, the polymer cleaning solution of Example 1 was added to a polymer that contained a mixture of a cationic (Nalco® 7194) and anionic polymer (Nalco® 7768).

The tests were conducted by adding varying amounts of the polymer cleaning solution to 20 grams (g) of the cationic polymer. The mixture was slightly stirred and 20 g of the anionic polymer was then added to the mixture. Next, an equal amount of the polymer cleaning solution that was previously added was again added to this mixture. 100 g of water was then added to the mixture and slightly stirred.

The viscosity of the mixture was measured after a five-minute interval. The measured viscosity for each of the polymer mixtures which have a varying amount of polymer cleaning solution were compared to a baseline viscosity of 15,000 centimeters per second (“cps”). The baseline viscosity was measured from a polymer mixture that contained 20 g of each of the cationic and anionic polymers and 100 g of water.

### Test Example 1

TABLE 1

| Polymer Cleaning | Viscosity |
|---|---|
| Solution (g) | (cps) |
| 1 g | 500 |
| 0.8 g | 1,200 |
| 0.6 g | 3,600 |
| 0.4 g | 12,000 |

As indicated from the table of Table 1, the viscosity of the polymer mixture was increasingly reduced upon adding greater amounts of the polymer cleaning solution to the polymer mixture.

### EXAMPLE 2

Laboratory tests were conducted to evaluate the effects of the halide salt and carboxylic acid component of the polymer cleaning solution. Four test solutions were prepared. Test solution 1 contained D.I. water at 79.8% by weight, calcium chloride dihydrate at 20% by weight and acetic acid at 0.2% by weight. Test solution 2 contained D.I. water at 80% by weight and calcium chloride dihydrate at 20% by weight. Test solution 3 contained D.I. water at 79.8% by weight, sodium chloride at 20% by weight and acetic acid at 0.2% by weight. Test solution 4 contained D.I. water at 80% by weight and sodium chloride at 20% by weight.

Each of the test solutions were added to the polymer mixture in 1 g amounts per 20 g of the polymers as performed in Example 1. The viscosity of the mixture (i.e., the polymers and the polymer cleaning agent) was measured after a one-hour period.

### Test Result 2

TABLE 2

| Test Solution | Viscosity (cps) |
|---|---|
| 1 | 1,600 |
| 2 | 4,000 |
| 3 | 10,000 |
| 4 | 15,000 |

As indicated in Table 2, test solution 1 that contains both the a halide salt (calcium chloride dihydrate) and a carboxylic acid (acetic acid) resulted in the greatest reduction of viscosity. As further indicated in Table 2, test solutions 1 and 3 which contain a carboxylic acid component in addition to acetic acid outperformed test solutions 2 and 4 which did not include acetic acid. Table 2 also indicated that a polymer cleaning solution containing calcium chloride dihydrate (test solution 2) outperforms one that contains sodium chloride (test solution 4).

### EXAMPLE 3

Laboratory tests were conducted to evaluate the effectiveness of polymer cleaning solutions that contain a halide salt and a carboxylic acid, namely, acetic acid. Three test solutions were prepared for Example 3. Test solution 1 contained D.I. water at 79.8% by weight, calcium chloride dihydrate at 20% by weight and acetic acid at 0.2% by weight. Test solution 2 contained D.I. water at 79.8% by weight, calcium chloride dihydrate at 20% by weight and hydrogen chloride at 0.2% by weight. Test solution 3 contained D.I. water at 79.8% by weight, calcium chloride dihydrate at 20% by weight and sulfuric acid at 0.2% by weight.

The test solutions were added to the polymers in 1 g amounts as previously conducted in Example 2. The viscosity of the mixture of polymers and cleaning agents were measured after a period of two hours.

### Test Rest 3

TABLE 3

| Test Solution | Viscosity (cps) |
|---|---|
| 1 | 3,200 |
| 2 | 5,600 |
| 3 | 6,200 |

As indicated in Table 3, test solution 1 that contained both calcium chloride dihydrate and acetic acid outperformed the other test solutions.

### Field Application

A polymer cleaning solution that contained D.I. water at 79.8% by weight, calcium chloride hydrate at 20% by weight and acetic acid at 0.2% by weight was prepared as indicated above and applied during field studies. The cleaning solution was applied to containers, such as totes, which are used to containerize polymers. The polymer cleaning solution was effectively utilized to clean the polymers and residuals thereof which remained in the totes at reduced cost and time of cleaning operation.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that all such changes and modifications be covered by the appended claims.

We claim:

1. A composition for removing polymers comprising a solution containing a carboxylic acid and a halide salt.

2. The composition of claim 1 wherein the carboxylic acid includes six or fewer carbon atoms.

3. The composition of claim 1 wherein the carboxylic acid is selected from the group consisting of acetic acid, ethanoic acid, propionic acid, butyric acid, oxalic acid, citric acid and mixtures thereof.

4. The composition of claim 1 wherein the halide salt includes a metal component and a halide component.

5. The composition of claim 4 wherein the metal component is selected from the group consisting of a monovalent metal, a divalent metal, Mg, Na, Ca, K and combinations thereof.

6. The composition of claim 4 wherein the halide component is selected from the group consisting of a halogen, I, Cl, Br and mixtures thereof.

7. The composition of claim 1 wherein the solution is an aqueous solution that contains a dye component and a fragrance component.

8. The composition of claim 1 wherein the solution has a pH that ranges from about 1.0 to about 4.0.

9. The composition of claim 1 wherein the halide salt ranges from about 1% to about 97% by weight.

10. The composition of claim 1 wherein the carboxylic acid ranges from about 0.01% to about 50% by weight.

11. A cleaning agent that can be used to remove polymers from a surface comprising an aqueous solution containing a carboxylic acid and a halide salt having a metal component and a halide component.

12. The cleaning agent of claim 11 wherein the carboxylic acid is selected from the group consisting of acetic acid, ethanoic acid, propionic acid, butyric acid, oxalic acid, citric acid and mixtures thereof.

13. The cleaning agent for claim 11 wherein the metal component is selected from the group consisting of a monovalent metal, a divalent metal, Mg, Na, Ca, K and mixtures thereof.

14. The cleaning agent of claim 11 wherein the halide component includes a halogen, I, Cl, Br or mixtures thereof.

15. The cleaning agent of claim 11 wherein the halide salt ranges from about 1% to about 97% by weight and wherein the carboxylic acid ranges from about 0.01% to about 50% by weight.

16. The cleaning agent of claim 11 wherein the halide salt is about 20% by weight and wherein the carboxylic acid is about 0.2% by weight.

17. The cleaning agent of claim 11 wherein the carboxylic acid is acetic acid and the halide salt is calcium chloride dihydrate.

18. A method of cleaning a polymer comprising the steps of:
providing a solution containing a halide salt and a carboxylic acid; and
applying the solution to the polymer.

19. The method of claim 18 further comprising the step of spraying the solution onto the polymer.

20. The method of claim 18 further comprising the steps of fluidizing the polymer by applying the solution to the polymer and removing the fluidized polymer.

21. The method of claim 20 wherein the fluidized polymer has a reduced viscosity as compared to the polymer.

22. The method of claim 18 further comprising removing the residual polymer from a storage container.

23. The method of claim 22 wherein the storage container comprises a storage tank, truck tank, intermediate bulk container, storage drum or combinations thereof.

24. The method of claim 18 further comprising the step of removing the polymer from a process equipment.

25. The method of claim 18 wherein the polymer comprises a molecular weight ranging from about 1000 amu to about 50,000,000 amu.

26. The method of claim 18 wherein the polymer is selected from the group consisting of a solution polymer, an emulsion polymer, a latex polymer, a dispersion polymer and mixtures thereof.

27. A method of removing a polymer comprising the steps of:
providing a cleaning solution containing a halide salt and a carboxylic acid;
applying the cleaning solution to the polymer during a spill cleanup; and
removing the polymer.

28. The method of claim 27 further comprising the step of removing the polymer during an industrial spill cleanup.

29. The method of claim 27 further comprising the step of removing the polymer during a tanker truck spill cleanup.

30. The method of claim 27 further comprising the step of removing the polymer during a train derailment spill cleanup.

31. The method of claim 27 wherein the polymer is selected from the group consisting of a solution polymer, an emulsion polymer, a latex polymer, a dispersion polymer and mixtures thereof.
